(19) United States
(12) Patent Application Publication
(10) Pub. No.: US 2005/0149493 A1
(43) Pub. Date: Jul. 7, 2005

(54) Data recording apparatus and data recording method

(76) Inventors: Kazuhiko Yamashita, Kyoto (JP); Yuichi Kato, Chiryu (JP)

Correspondence Address: WENDEROTH, LIND & PONACK, L.L.P., 2033 K STREET N. W., SUITE 800, WASHINGTON, DC, 20006-1021, US

(21) Appl. No.: 11/028,614

(22) Filed: Jan. 5, 2005

(30) Foreign Application Priority Data
Jan. 7, 2004 (JP) 2004-001639

(51) Int. Cl. G06F 17/30

(52) U.S. Cl. 707/2

(57) ABSTRACT

A data recording apparatus is provided with a recording medium. In addition, the data recording apparatus is provided with a file data list management unit and a file index list management unit. The file data list management unit receives file data constituting a plurality of files, on a file-by-file basis, and then records the received file data to the recording medium. Upon completion of the recording of the file data to the recording medium, the file index list management unit generates specification information associated with the files to which the received file data relates. The file index management unit then records the generated specification information to the recording medium 107.

### BACKGROUND OF THE INVENTION

(1) Field of the Invention

The present invention relates to an apparatus and method for recording data onto a recording medium, such as a semiconductor memory, an optical disc, and a magneto-optical disc, and also to a computer program pertinent to the apparatus and method. More particularly, the present invention relates to a technique for avoiding inconsistency that is likely to occur between the actual data storage condition and file management information showing the data storage condition due to an abnormal termination of a write operation.

(2) Description of the Related Art

In one file system, when an information device (such as a personal computer) writes data in a file format onto a recording medium (such as a hard disk), the data is not written in one contiguous area of the recording medium. Rather, the data is divided into pieces to be written into a plurality of separate clusters. In order to keep track of the recorded data, the file system employs an FAT (File Allocation Table) and a file index. The FAT shows the addresses of clusters storing the data, along with the sequence of the clusters. The file index shows the name of each file in association with the start address of the file data. See for example “Volume & File Structure of Disk Cartridge for Information Interchange” (JIS X 0605-1990).

With the file system employing an FAT and a file index, an abnormal termination of a data write operation due to a power failure often causes inconsistency between the FAT and the file index upon restarting the information device. Thus, some information devices are provided with a recovering function to eliminate such inconsistency. See, for example, JP patent application publication No. 2002-063057.

FIG. 9 is a functional block diagram showing the structure of a data recording apparatus 800 having the recovering function mentioned above.

Hereinafter, a description is given to processing of the data recording apparatus 800, with reference to FIG. 9. Specifically, the description is given to the data write processing as well as to the recovery processing that is carried out after the data wire processing is accidentally terminated due to a power fairer, for example.

Write Processing

The data recording apparatus 800 is composed of a first FAT update unit 801, a second FAT update unit 802, a file index update unit 803, a temporary index generating unit 804, a temporary index erasing unit 805, a data update unit 806, a recovery processing unit 807, an FAT comparing unit 808, a file index comparing unit 809, and a recording medium 80. The recording medium 80 stores a first FAT 810, a second FAT 811, a file index 812, a temporary index 813, and data clusters 814.

The first FAT 810 and the second FAT 811 are supposed to be identical in content, except during the write processing and after an abnormal termination. The two FATs are used to identify a processing step at which an abnormal condition takes palace.

When the data update unit 806 updates one of files recorded on the recording medium 80, the temporary index generating unit 804 generates and records the temporary index 813, prior to the update of the file index 812 that is associated with the updated one of the files. The temporary index 813 includes the content of the file index 812 associated with the updated one of files.

Next, the first FAT update unit 801 updates the first FAT 810, whereas the file index update unit 803 updates the file index 812 both to reflect the file update.

In addition, the second FAT update unit 802 updates the second FAT 811 so as to bring the contents of the second FAT 811 in consistency with the first FAT 810, which has already been updated. Finally, the temporary index erasing unit 805 erases the temporary index 813 from the recording medium 80.

Recovery Processing

At the time of restarting the data recording apparatus 800 after an abnormal termination of the write processing, the file index comparing unit 809 judges whether the temporary index 813 is stored on the recording medium 80. When the temporary index 813 is not stored, it is judged that the abnormal termination took place before or after, but not during, the update of FATs 810 and 811 and the file index 812. Thus, the recovery processing is completed.

On the other hand, when the temporary index 813 is stored, the FAT comparing unit 808 reads and compares the first and second FATs 810 and 811 to see whether there is a difference therebetween. When there is no difference, it is judged that the abnormal termination took place after updating the FATs 810 and 811 and the file index 812. Thus, the temporary index erasing unit 805 simply erases the temporary index 813 from the recording medium 80, thereby completing the recovery processing.

When there is a difference between the two FATs, the file index comparing unit 809 compares the temporary index 813 with the file index 812 to see if there is a difference.

In the case where there is no difference between the two indexes, it is judged that the abnormal termination took place before updating the second FAT 811. Thus, the second FAT updating unit 802 updates the second FAT 811 by overwriting, with the first FAT 810, the storage area of the recording medium 80 dedicated to the second FAT 811. As a result, the second FAT 811 is brought into consistency with the file index 812. The temporary index erasing unit 805 then erases the temporary index 813 from the recording medium 80. This completes the recovery processing.

On the other hand, in the case where there is a difference between the two indexes, it is judged that the abnormal termination took place after the update of the first FAT 810 and before the update of the file index 812. Thus, the first FAT update unit 801 overwrites, with the second FAT 811, the storage area of the recording medium 80 dedicated to the first FAT 810. As a result, the first FAT 810 is brought back into consistency with the file index 812. The temporary index erasing unit 805 then erases the temporary index 813 from the recording medium 80. This completes the recovery processing.

Unfortunately, however, the above recovery processing performed by the data recording apparatus 800 manages to eliminate inconsistency among the FATs and the file index that may occur as a result of an abnormal termination, provided that a single file is subjected to update. Yet, the above recovery processing is not applicable to the case where mutually related multiple files are to be updated at once.

As examples, consideration is given to the case of a music data file and a score data file associated with the music data or to the case where a plurality of files together constitutes a web site. Those files present valuable information provided that the files are used in conjunction with one another. Thus, it is not enough to eliminate the data inconsistency on a file-by-file basis. Without consistency throughout all files in terms of updates made to the files, some of the files read may be the updated version, while the rest of the files read may be the pre-update version. As a result, there is a problem that no valuable information can be reproduced from those files.

Furthermore, in order to eliminate inconsistency among the FATs and file index that may result from an abnormal termination, the data recording apparatus 800 performs the recovery processing at the time of restarting. Naturally, an extra processing load is imposed.

### SUMMARY OF THE INVENTION

In view of the above problem, the present invention aims to provide a data recording apparatus and method allowing, without the need for any recovering processing, an access to a plurality of files under a condition that consistency among the files is maintained even after restarting the apparatus subsequent to an abnormal termination of a recording or updating operation to the files.

To achieve the above aim, one aspect of the present invention provides a data recording apparatus having a recording medium, for accessing files on the recording medium with reference to specification information used for specifying storage locations of the files. The recording apparatus includes: a data receiving unit operable to receive file data constituting a plurality of files, on a file-by-file basis; a data recording unit operable to record the received file data onto the recording medium; and a specification information recording unit operable to, on completion of the recording of the received file data, generate and record to the recording medium, specification information for the files constituted of the received file data.

In another aspect, the present invention provides a data recording method for use by a data recording apparatus having a recording medium and accessing files on the recording medium with reference to specification information used for specifying storage locations of the files. The data recording method comprising the steps of: receiving file data constituting a plurality of files, on a file-by-file basis; recording the received file data onto the recording medium; and generating and recording to the recording medium, on completion of the recording of the received file data, specification information for the files constituted of the received file data.

In yet another aspect, the present invention provides a program for use by a data recording apparatus having a recording medium and accessing files on the recording medium with reference to specification information used for specifying storage locations of the files file. The program comprising: code operable to cause the apparatus to receive file data constituting a plurality of files, on a file-by-file basis; code operable to cause the apparatus to record the received file data onto the recording medium; and code operable to cause, on completion of the recording of the received file data, the apparatus to generate and record to the recording medium, specification information for the files constituted of the received file data.

In yet another aspect, the present invention provides a computer-readable recording medium storing a program for used by a data recording apparatus having another recording medium and accessing files on said another recording medium with reference to specification information used for specifying storage locations of the files. The program comprising: code operable to cause the apparatus to receive file data constituting a plurality of files, on a file-by-file basis; code operable to cause the apparatus to record the received file data onto the recording medium; and code operable to cause, on completion of the recording of the received file data, the apparatus to generate and record to the recording medium, specification information for the files constituted of the received file data.

The structures stated above ensures, without the need for any recovery processing, that consistency among the files is maintained and the files are duly accessible even after a startup subsequent to an abnormal termination of data recording to the files.

Here, the recording medium may store (i) file data constituting files being a pre-update version of the files constituted of the received file data, and (ii) specification information for the pre-update version of files. The specification information recording unit invalidates the previously stored specification information, and validates the specification information generated on completion of the recording of the received file data.

Here, the data recording apparatus may further include a storage location recording unit operable to, each time the recording of the received file data is completed for one file, generate and record to the recording medium a piece of storage location information showing a storage location of the file. An access to the file is made with reference to the storage location information. The specification information specifies a storage location of each piece of storage location information. The specification information recording unit generates the specification information, on completion of the recording of the storage location information for the files constituted of the received file data.

The structures stated above ensures, without the need for any recovery processing, that consistency among the files is maintained and the files are duly accessible even after a startup subsequent to an abnormal termination of update processing of the files.

Here, the recording medium may include: a file data recording area composed of a plurality of clusters; and a table recording area storing a cluster usage table showing a usage condition of the clusters. The data recording unit may include: a cluster specifying subunit operable to specify, with reference to the cluster usage table, unused clusters available for storing the received file data; a cluster recording subunit operable to record the received file data to the specified clusters; an updated table generating subunit operable to generate a cluster usage table in which a usage condition of the specified clusters is updated; and a table update subunit operable to record the generated cluster usage table to the recording medium, on completion of the recording of the storage location information for the files.

With the above stated structure, the cluster usage table showing the updated usage condition of the clusters is recorded to the recording medium after completing the recording of all file data to the recording medium. Thus, in the file data update that is redone after a start up subsequent to an abnormal termination of the file data recording, it is avoided that an updated version of the cluster usage table is referenced, which is likely to cause such a problem that unused clusters are incorrectly regarded as used clusters.

Here, the data recording apparatus may further include a group file specifying unit operable to specify a plurality of files to be updated as a group. The data receiving unit receives the file data for the specified group of files.

With the above stated structure, a plurality of files to be updated as a group can be freely specified as necessary.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a functional block diagram showing the structure of a data recording apparatus 100 consistent with an embodiment of the present invention;

FIG. 2A is a view showing a specific example of a file data list 114;

FIG. 2B is a view showing a specific example of another file data list 114;

FIG. 2C is a view showing a specific example of an updated file data list 114 that overwrites the file data list 114 shown in FIG. 2B;

FIG. 3A is a view showing a specific example of a file index list;

FIG. 3B is a view showing a specific example of another file index list;

FIG. 3C is a view showing a specific example of an updated file index list 111 that overwrites the file index list 111 shown in FIG. 3B;

FIG. 4A is a view showing a pre-update version of a file index 112 associated with a file named “FILE 1”;

FIG. 4B is a view showing a post-update version of the file index 112 shown in FIG. 4A;

FIG. 4C is a view showing a pre-update version of a file index 112 associated with a file named “FILE 2”;

FIG. 4D is a view showing a post-update version of the file index 112 shown in FIG. 4B;

FIG. 5 is a flowchart of the procedural steps of file update processing performed by the data recording apparatus 100;

FIG. 6 is a view showing a specific example of a file system information 110;

FIG. 7 is a table showing the files and file indexes 112 that are stored in the recording medium 107 as well as the file index list 111 and the file data list that are valid, all at the time of startup after an abnormal termination of the file update processing occurred in a respective step shown in FIG. 5;

FIG. 8 is a flowchart of the procedural steps file update preparatory processing performed by a file update control unit 105; and

FIG. 9 is a functional block diagram showing the structure of a conventional data recording apparatus 800.

### DESCRIPTION OF THE PREFERRED EMBODIMENT

Now, a description is given to a preferred embodiment of the present invention, with reference to the accompanying drawings.

### EMBODIMENT

I. Structure

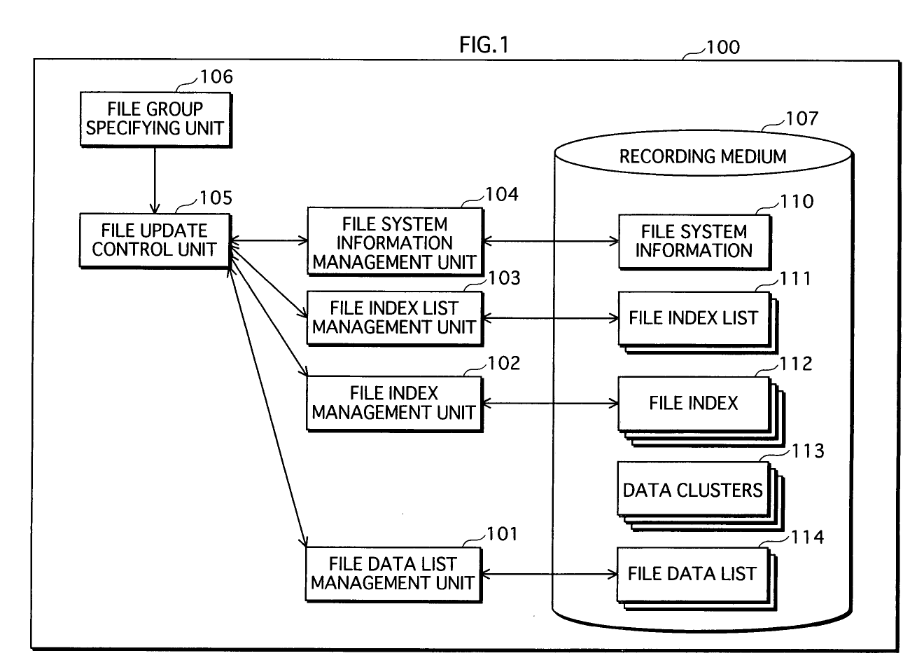

FIG. 1 is a functional block diagram showing the structure of a data recording apparatus 100 consistent with an embodiment of the present invention. The data recording apparatus 100 is composed of a file data list management unit 101, a file index management unit 102, a file index list management unit 103, a file system information management unit 104, a file update control unit 105, a file group specifying unit 106, and a recording medium 107.

In terms of hardware, the data recording apparatus 100 is composed generally of a CPU, a ROM, a RAM, and a hard disk or another recording medium (a flash memory such as a memory card or an optical disc such as DVD (Digital Video Disc)). The ROM or hard disk stores a computer program for implementing the functions of the data recording apparatus 100. The data recording apparatus 100 carries out its functions by the CPU operating in accordance with the computer program.

Also, the ROM or the hard disk stores a plurality of application programs and system programs.

The file data list management unit 101 reads file data lists 114 from the recording medium 107 in response to a file data list read instruction issued from the file update control unit 105. The file data list management unit 101 then outputs the read file data lists 114 to the file update control unit 105. Also, the file data list management unit 101 updates the file data list 114 in response to a file data list update instruction issued from the file update control unit 105.

Specifically speaking, the file data list management unit 101 first identifies the most recently updated one of the file data lists 114 having been read from the recording medium 107, based on the time stamps. With reference to the most recently updated file data list 114, the file data list management unit 101 specifies the cluster numbers of unused cluster to allocate the file data inputted from the file update control unit 105. The file data list management unit 101 then stores the file data to the thus specified clusters, and updates the file data list 114 to show that the clusters of the specified cluster number are now being used. In addition, when the file update control unit 105 informs, upon issuance of the file data list update instruction, the cluster numbers of clusters that are no longer used as a result of the file update, the file data list management unit 101 updates the file data list 114 so as to show that the clusters of the informed cluster numbers are now unused.

Note that the file data lists 114, the time stamps, and the clusters are described later in detail.

In response to a file data list recording instruction issued from the file update control unit 105, the file data list management unit 101 overwrites the least recently updated one of the file data lists 114 based on the time stamps with the updated version of the file data list 114. The file data list management unit 101 then rewrites the time stamp of the updated file data list 114 to the value indicating that the time of the current update (i.e. the updated file data list 114 is now the most recently updated one).

The “file data list” is a table showing the usage condition of the clusters. In this embodiment, the recording medium 107 stores two file data lists 114 that are alternately updated by the file data list management unit 101. Upon each update, the updated one of the file data lists 114 is time stamped to indicate the time of the update.

The time stamp may be a value corresponding to a current time or a value with a predetermined increment or decrement from the time stamp given upon an immediately previous update, so that the old and new of the file data lists 114 can be known. More specifically, in the case of giving a time stamp of an incremented value on each update, one of the file data lists 114 on the recording medium 107 bearing a larger value time stamp is judged to be most recently updated. At the time of a subsequent update, a time stamp of a value with a predetermined increment from the immediately previous time stamp value is given to the other of the file data lists 114. On the other hand, in the case of giving a time stamp of a decremented value on each update, one of the file data lists 114 on the recording medium 107 having a smaller value time stamp is judged to be most recently updated. At the time of a subsequent update, a time stamp of a value with a predetermined decrement from the immediately previous time stamp value is given to the other of file data lists 114.

As later described, the file index lists 111 may also time stamped in the same manner described above regarding the file data lists 114. Thus, the same update version of the file data lists 114 and the file index lists 111 are given the time stamps of the same value. More specifically, the most recently updated file data list 114 bears the same time stamp as the most recently updated file index list 111, whereas the least recently updated file data list 114 bears the same time stamp as the least recently updated file index list 111.

The “cluster” is a unit referring to an evenly divided part of the data recording area of the recording medium 107. One cluster is composed of one or more contiguous sectors.

The “sector” is the smallest accessible unit for reading and writing of the recording area of the recording medium 107, except the data recording area. The sectors of the recording medium 107 are numbered in consecutive order, including the sectors of the data recording area. Write and read accesses to the recording area, except to the data recording area, of the recording medium 107 are made by specifying the sector numbers. In the case of the hard disk of a personal computer, for example, the size of one sector is 512 bytes.

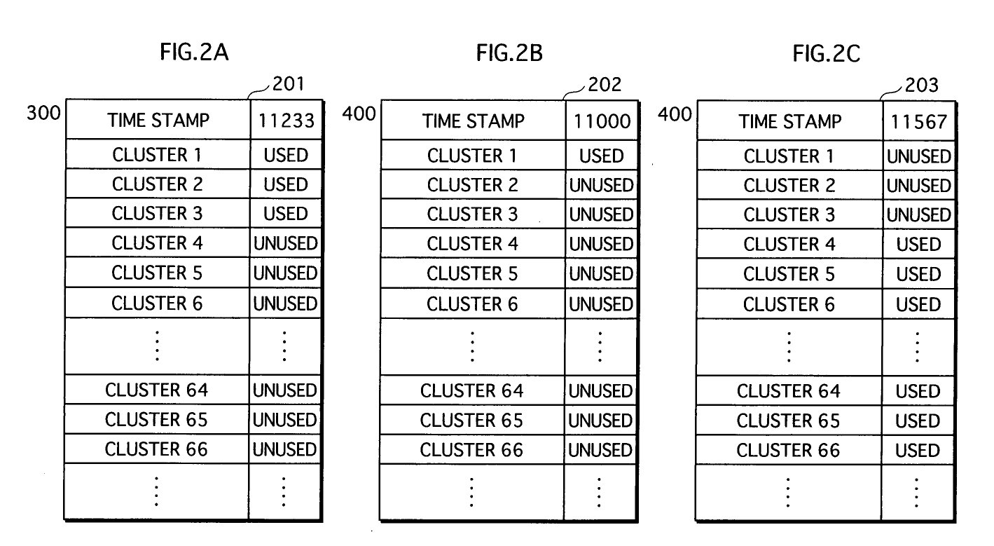

FIGS. 2A and 2B each show a specific example of the file data lists 114. The file data list 114 shown in FIG. 2A has a larger value time stamp and thus is the most recently updated version (hereinafter may be denoted by the reference numeral 201). Each of the file data lists 114 in FIGS. 2A and 2B shows the time stamp, the cluster numbers serving as the addresses of the respective clusters on the recording medium 107, and the usage condition of the respective clusters.

The usage condition, “USED” means that the cluster having a corresponding cluster number currently stores a fragment of file data. On the other hand, the usage condition “UNUSED” means that the cluster having a corresponding cluster number contains no file data fragment.

The file index management unit 102 reads file indexes 112 from the recording medium 107 in response to a file index read instruction issued from the file update control unit 105, and outputs the read file indexes 112 to the file update control unit 105. Also, the file index management unit 102 updates the file index 112 in response to a file index update instruction issued from the file update control unit 105, and records the updated file index 112 to the recording medium 107.

The “file index” is a table generated for each file that is newly generated or updated. The table shows the cluster numbers of data clusters 113 and the sequence of data clusters 113. Note that the data clusters 113 are clusters containing file data fragments that together constitute the file generated or updated. The cluster number of each data cluster serves as an address on the recording medium 107. In addition, the table is attached with a file name identifying an associated file.

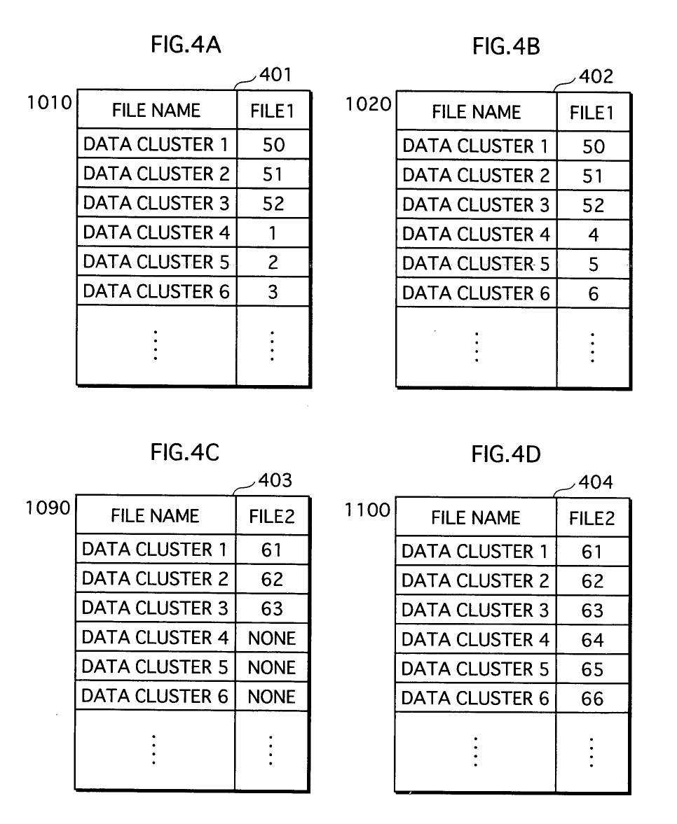

FIG. 4A shows a specific example of the file index 112 which may hereinafter be denoted by the reference numeral 401. The file index 401 is associated with a pre-update version of the file of which file name is “FILE 1”. FIG. 4B shows a specific example of the file index 112 which may hereinafter be denoted by the reference numeral 402. The file index 402 is a post-update version of the file index 112 (i.e. 401) shown in FIG. 4A. Similarly, FIGS. 4C and 4D show specific examples of the file indexes 112 which may hereinafter be denoted by the reference numerals 403 and 404, respectively. The file indexes 403 and 404 are both associated with the file of which file name is “FILE 2”, and the former is a pre-update version and the latter is a post-updater version.

Furthermore, the number shown in each of the FIGS. 4A-4D on the upper left is the sector number of the first sector in which the respective file index 112 is stored. As shown in the figures, the file indexes 401 and 402, which are pre- and post-update versions of the file index 112 of “FILE 1”, are separately stored in different sectors on the recording medium 107. Similarly, the file indexes 403 and 404, which are pre- and post-update versions of the file index 112 of “FILE 2”, are separately stored in different sectors on the recording medium 107.

In each file index 112 (i.e. 401-404), the data cluster numbers indicate the sequence of the data clusters 113 to be put together. Also, the numbers associated with the respective data cluster numbers are the cluster numbers serving as the addresses of the respective data clusters on the recording medium 107.

The file index list management unit 103 reads the file index lists 111 from the recording medium 107, in response to a file index list read instruction issued from the file update control unit 105, and outputs the read file index lists 111 to the file update control unit 105. Also, the file index list management unit 103 updates the file index list 111 in response to a file index list update instruction issued from the file update control unit 105, and records the updated file index 111 to the recording medium 107.

The “file index list” is a table showing the sector numbers serving as addresses of the file indexes 112 on the recording medium 107. In this embodiment, the recording medium 107 stores two file index lists 111. The two file index lists 111 are alternately updated by the file index list management unit 103. Upon each update, the updated one of the file index lists 111 is time stamped to indicate the time of the update.

As mentioned above, the file index lists 111 are time stamped in the same manner as the file data lists 114.

Specifically, the above recording of the updated file index list 111 to the recording medium 107 is carried out in response to the file index list update instruction in the following manner. First, the file index list management unit 103 overwrites the least recently updated one of the file index lists 111 based on the time stamps with the updated version of the file index list 111. Next, the time stamp of the updated one of the file index lists 111 is rewritten to the value corresponding to the time of the update.

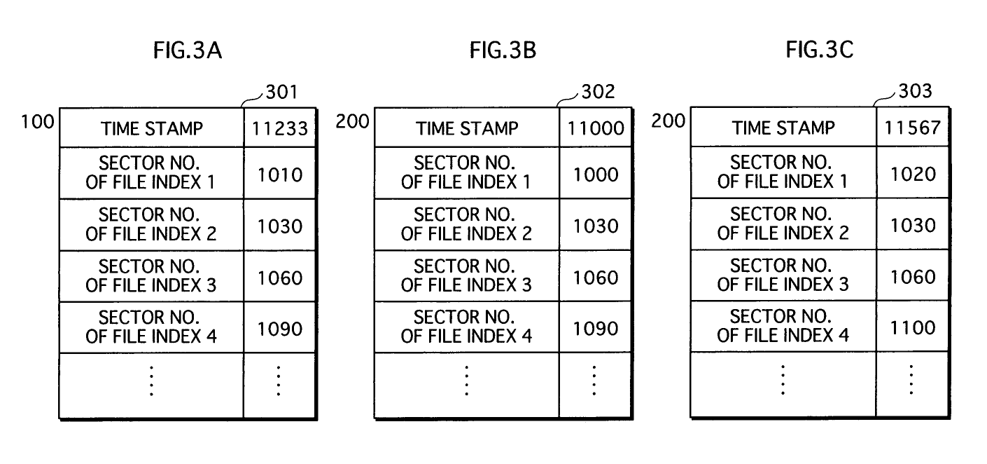

FIGS. 3A and 3B show specific examples of the file index lists 111, which may hereinafter be denoted by the reference numerals 301 and 302, respectively. The file index list 301 has a larger value time stamp and thus is the most recently updated one of the file index lists 111. Each file index list 111 in FIGS. 3A and 3B shows the time stamp and the sector numbers serving as the addresses of the file indexes 112 on the recording medium 107.

The file system information management unit 104 reads the file system information 110 from the recording medium 107, in response to a file system information read instruction issued from the file update control unit 105.

The “file system information” is a table showing the sector numbers serving as the addresses of the index lists 111 and the file data lists 114 on the recording medium 107.

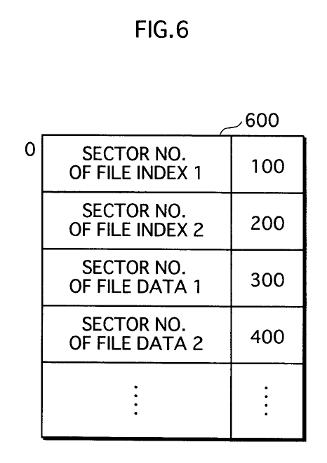

FIG. 6 shows a specific example of the file system information 110.

The file update control unit 105 is provided with a memory, such as a RAM, that temporarily stores information while the power is on and loses its contents when the power is turned off. The file update control unit 105 performs the file update preparatory processing and the file update control processing, both of which will be described below.

1. File Update Preparatory Processing

On startup of the data recording apparatus 100, the file update control unit 105 issues a file system information read instruction to the file system information management unit 104. In response, the file update control unit 105 loads the file system information 110 from the file system information management unit 104 to the RAM. With reference to the file system information 110 residing on the RAM, the file update control unit 105 specifies the addresses of the two file index lists 111 and of the two file data lists 114.

Next, the file update control unit 105 outputs the specified addresses of the file data lists 114 to the file data list management unit 101, along with a file data list read instruction. In response, the file update control unit 105 loads the two file data lists 114 from the file data list management unit 101 to the RAM. The file update control unit 105 then designates, as a valid file data list, the most recently updated one of the file data lists 114 based on the time stamps. The thus designated valid file data list 114 is informed to the file data list management unit 101.

Next, the file update control unit 105 outputs the addresses of the two file index lists 111 to the file index list management unit 103, along with a file index list read instruction. In response, the file update control unit 105 loads the two file index lists 111 from the file index list management unit 103 to the RAM. One of the file index lists 111 is then designated as a valid file index list 111 in the following manner.

Specifically, with reference to the time stamps of the two file index lists 111 on the RAM, the file update control unit 105 specifies the most recently updated file index list 111. Then, the file update control unit 105 judges whether the time stamp of the specified file index list 111 matches either of the time stamps of the two file data lists 114. If there is a match, it is judged the file data list 114 associated with the specified file index list 111 is present in the recording medium 107, and thus the specified file index list 111 is designated as a valid file index list 111. On the other hand, if there is no match, it is judged that the file data list 114 associated with the specified file index list 111 is not present in the recording medium 107. Thus, the other file index list 111 (i.e. the least recently updated file index list 111) is designated as a valid file index list 111. The thus designated valid file index list 111 is informed to the file index list management unit 103.

Next, the file update control unit 105 specifies the addresses of the file indexes 112, with reference to the valid file index list 111. The file update control unit 105 then outputs the addresses of the file indexes 112 to the file index management unit 102, along with an instruction instructing the file index management unit 102 to read the respective file indexes 112. In response, the file update control unit 105 loads the file indexes 112 from the file index management unit 102 to the RAM.

2. File Update Control Processing

Next, the file update control unit 105 receives from the file group specifying unit 106 an instruction for updating multiple files as a group and also receives update data for each file. In response, the file update control unit 105 divides, on a file-by-file basis, the update data into fragments to be stored in clusters. The file update control unit 105 then outputs the update data fragments to the file data list management unit 101, along with an instruction for updating the respective files using the update data. In response, the file data list management unit 101 allocates clusters to the update data fragments. Then, the file update control unit 105 updates the file data list 114 on the RAM so as to indicate that the newly allocated clusters are now “used”.

If there are any clusters that are no longer used as a result of the file updates, the file update control unit 105 informs the file data list management unit 101 about the cluster numbers of such clusters. In response, the file data list management unit 101 updates the file data list 114 on the RAM so as to indicate that those clusters are now “unused”.

The file update control unit 105 receives from the file data list management unit 101 the cluster numbers of clusters allocated to the update data. With reference to the file index 112 associated with the file to which the update data relates, the file update control unit 105 identifies the sequence of the allocated clusters to be put together. The file update unit 105 then informs the file index management unit 102 about the cluster numbers, its sequence, the file name, as well as the cluster numbers of no longer used cluster if any, and instructs the file index management unit 102 to update the file index 112. In response, the file index management unit 102 updates the file index 112 associated with the informed file name.

After the update of all of the file indexes 112 associated with the group files, the file update control unit 105 receives from the file index management unit 102, the sector numbers of sectors storing the file indexes 112 associated with the pre-update files as well as the post-update files. The file update control unit 105 then outputs the received sector numbers to the file index list management unit 103, along with an instruction for the update of the file index list 111. In response, the file index list management unit 103 generates an updated version of the valid file index list 111 that indicates the updated sector numbers. The file index list management unit 103 then records the updated version of the file index list 111 back to the recording medium 107, thereby updating the file index list 111. In addition, the file update control unit 105 instructs the file data list management unit 101 to write the file data list 114 currently on the RAM back to the recording medium 107, thereby updating the file data list 114.

The file group specifying unit 106 outputs to the file update control unit 105, an instruction for updating multiple files as a group, along with update data for each of the files instructed to be updated.

Here, the files to be updated as a group and the contents of update data of each file may be determined by user operations or by an application program.

The recording medium 107 is composed of a non-volatile recording medium, which is capable of retaining its contents even after the power is turned off. Examples of a non-volatile recording medium include a magnetic disk such as a hard disk, a magneto-optical disc such as a DVD, and a flash memory such as a memory card. The recording medium 107 stores the file system information 110, the file index lists 111, the file indexes 112, the data clusters 113, and the file data lists 114.

II. Operation

Now, a description is given to procedural steps the file update preparatory processing performed by the file update control unit 105.

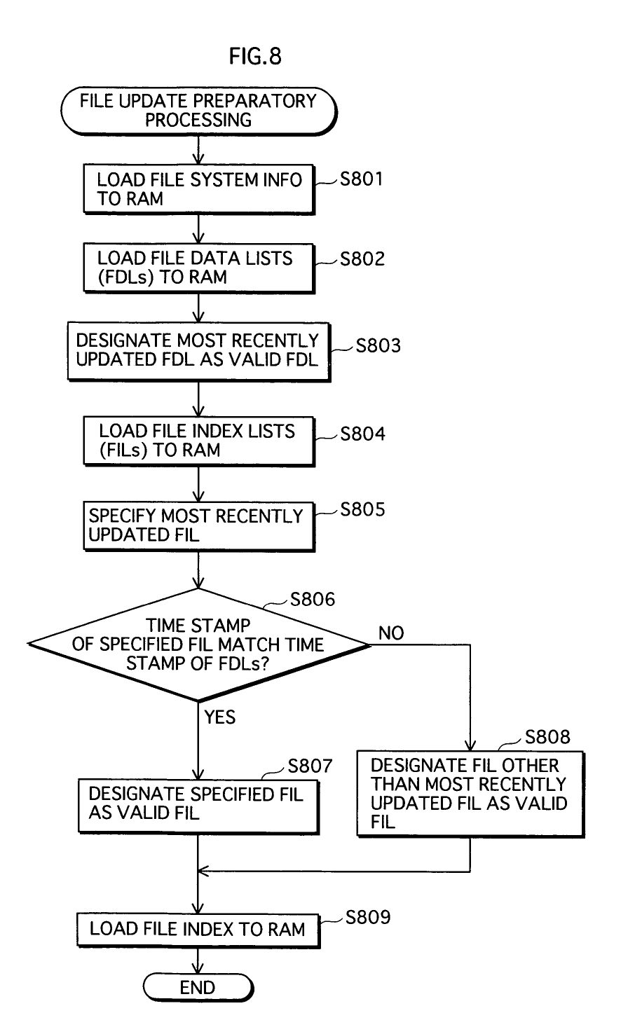

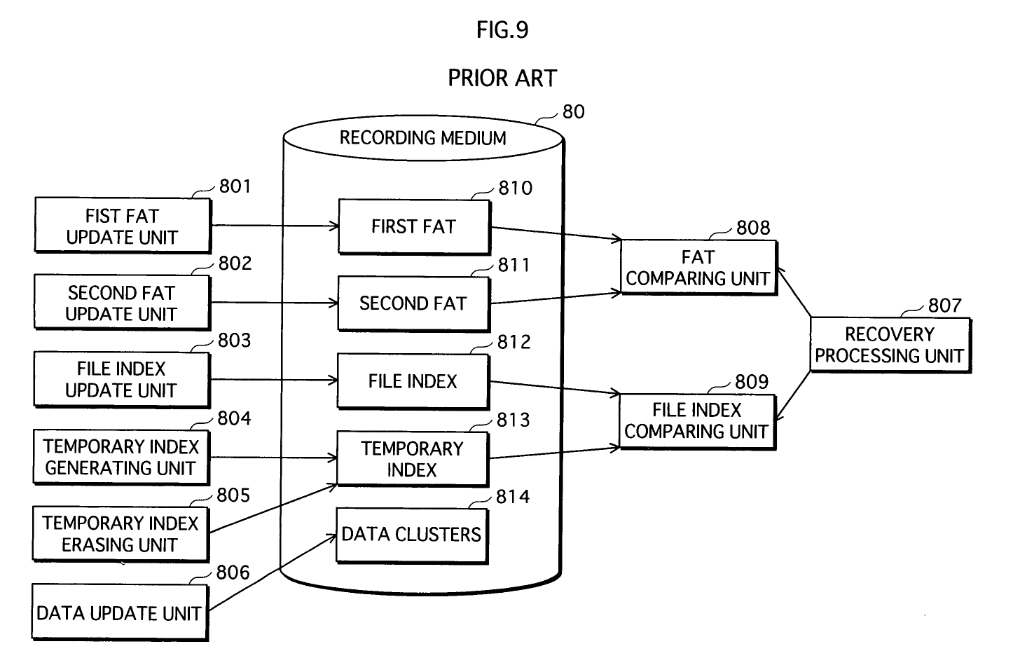

FIG. 8 is a flowchart of the procedural steps mentioned above, and the description hereinafter is given with reference to FIG. 8.

Upon startup of the data recording apparatus 100, the file update control unit 105 issues a file system information read instruction to the file system information management unit 104. In response, the file update control unit 105 loads the file system information 110 from the file system information management unit 104 to the RAM (step S801). With reference to the file system information 110 on the RAM, the file update control unit 105 specifies the addresses of the two file index lists 111 and of the two file data lists 114. The file update control unit 105 then outputs the thus specified addresses of the file data lists 114 to the file data list management unit 101, along with a file data list read instruction. In response, the file update control unit 105 loads the two file data lists 114 from the file data list management unit 101 to the RAM (step S802). Based on the time stamps of the file data lists 114 on the RAM, the file update control unit 105 designates, as a valid file data list, one of the file data lists 114 that is most recently updated (step S803). The valid file data list 114 is informed to the file data list management unit 101.

Next, the file update control unit 105 outputs the specified addresses of the file index lists 111 to the file index list management unit 103, along with a file index list read instruction. In response, the file update control unit 105 loads the file index lists 111 from the file index list management unit 103 to the RAM (step S804). Based on the time stamps of the two file index lists 111 on the RAM, the file update control unit 105 specifies one of the file index lists 111 that is most recently updated (step S805). The file update control unit 105 then judges whether the time stamp of the thus specified file index list 111 matches any of the time stamps of the file data lists 114 residing on the RAM (step S806).

When there is a match (step S806, YES), it is judged that the file data list 114 associated with the specified file index list 111 is present in the recording medium 107. Thus, the file update control unit 105 designates the specified file index list 111 as a valid file index list 111 (step S807). On the other hand, when there is no match (step S806, NO), it is judged that the file data list 114 associated with the specified file index list 111 is not present in the recording medium 107. In this case, the other file index list 111, which is the least recently updated one, is designated as a valid file index list 111 (step S808). The file update control unit 105 then informs the valid file index list 111 to the file index list management unit 103.

Next, with reference to the valid file index list 111, the file update control unit 105 specifies the addresses of the file indexes 112. The file update control unit 105 then outputs the thus specified addresses of the fie indexes 112 to the file index management unit 102, along with an instruction for reading the respective file indexes 112. In response, the file update control unit 105 loads the file indexes 112 from the file index management unit 102 to the RAM (step S809).

Next, a description is given to procedural steps of the file update processing performed by the data recording apparatus 100.

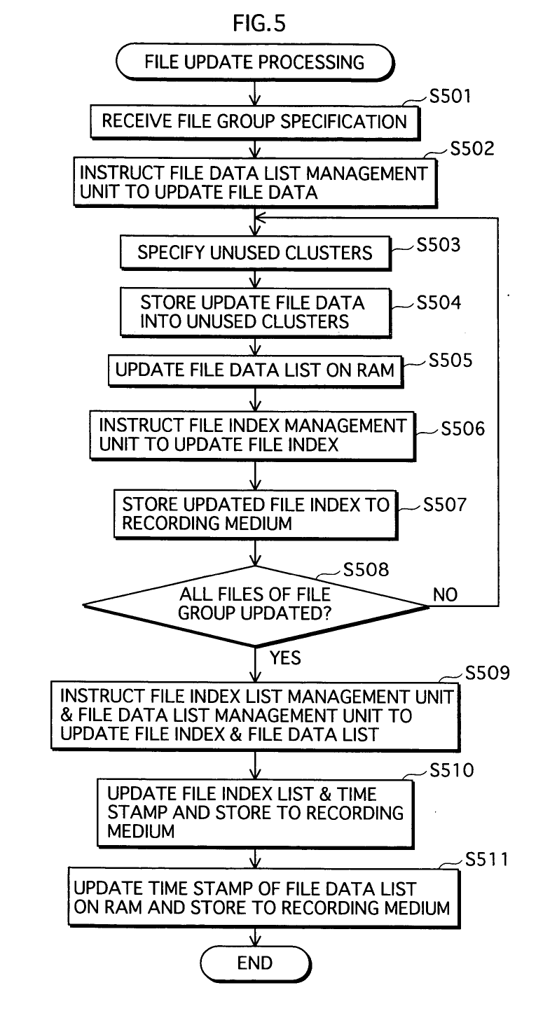

FIG. 5 is a flowchart of the procedural steps mentioned above, and the description hereinafter is given with reference to FIG. 5.

After the file update preparatory processing, the file update control unit 105 receives from the file group specifying unit 106, an instruction for updating multiple files as a group (hereinafter, referred to as “group files”) and also receives update data for each of the group files (step S501). The file update control unit 105 then divides, on a file-by-file basis, the update data into a plurality of fragments to be stored in clusters, and outputs the update data fragments to the file data list management unit 101, along with an instruction for updating the respective group files using the update data (step S502). In the case where there is any clusters that are no longer used as a result of the file update, the file update control unit 105 informs the file data list management unit 101 about the cluster numbers of such clusters.

On receiving the file data update instruction from the file update control unit 105, the file data list management unit 101 refers to the valid file data list 114 residing on the RAM to specify the cluster numbers of as many unused clusters as the update data fragments (step S503). Then, the file data list management unit 101 allocates the specified unused clusters one by one to the update data fragment without overlap, and stores the update data fragments to the allocated clusters (step S504). The file data list management unit 101 then updates the valid file data list 114 to indicate that the clusters allocated above as now used. In the case where it is informed that any clusters are no longer used as a result of the file update, the file data list management unit 101 further updates the file data list 114 on the RAM so as to indicate that such clusters are now unused (step S505). Finally, the file data list management unit 101 informs the file update control unit 105 about the cluster numbers of the newly allocated clusters as the data cluster numbers.

On receiving the data cluster numbers from the file data list management unit 101, the file update control unit 105 refers to the file index 112 associated with the updated file to identify the sequence of the data clusters. The file update control unit 105 informs the file index management unit 102 about the data cluster numbers, the sequence of the data clusters, and the name of the updated file, as well as the cluster numbers of clusters that are no longer used, if any. The file update control unit 105 then instructs the file index management unit 102 to update the file index 112 (step S506).

Based on the name of the updated file informed from the file update control unit 105, the file index management unit 102 specifies the file index 112 to be updated, from among the file indexes 112 residing on the RAM. The file index management unit 102 then updates the specified file index 112 on the RAM by writing the informed data cluster numbers in the informed sequence. In addition, in the case where there has been informed any cluster numbers of clusters that are no longer used, the file index management unit 102 further updates the specified file index 112 by deleting the data cluster numbers corresponding to the unused clusters. The file index management unit 102 then writes the updated file index 112 back to the recording medium 107 (step S507).

Next, the file update control unit 105 judges whether the update is completed for all of the group files specified by the file group specifying unit 106 (step S508).

In the case where all of the group files have been updated (step S508: YES), the file update control unit 105 receives from the file index management unit 102 the sector numbers of sectors serving as the addresses of the file indexes 112 that are associated with both the pre-update and the post-update version of each file. The file update control unit 105 then informs the received sector numbers to the file index list management unit 103. In addition, the file update control unit 105 instructs the file index list management unit 103 to update the file index list 111, and the file data list management unit 101 to update the file data list 114 (step S509).

The file index list management unit 103 receives, from the file update control unit 105, a file index list update instruction and the sector numbers of the file indexes 112 associated with both the pre-update version and the post update version of each file. Then, the file index list management unit 103 updates the valid file index list 111 residing on the RAM by rewriting the sector numbers of the file indexes 112 of the pre-update version to the sector numbers of the post-update version. The file index list management unit 103 also rewrites the time stamp to indicate the file index list 111 is the most recently updated one (for example, by incrementing the value of time stamp). Finally, the file index list management unit 103 writes the thus updated file index list 111 back to the recording medium 107 by overwriting the other file index list 111 not determined as a valid one (i.e. the least recently updated file index list 111) (step S510).

If it is judged in the step S508 that all of the group files have not yet been updated (step S508: NO), the processing returns to the step S503.

Next, on receiving a file data list update instruction from the file update control unit 105, the file data management unit 101 rewrites the time stamp of the file data list 114 on the RAM that is updated in the step S505 to indicate that the file data list 114 being processed is the most recently updated one (for example, by incrementing the time stamp by a predetermined number). The file update control unit 105 then writes the updated file data list 114 back to the recording medium 107 by overwriting the least recently updated file data list 114 (step S511).

Next, a description is given to the file update preparatory processing performed by the file update control unit 105 upon a startup of the data recording apparatus 100, following an abnormal termination that takes place during the file update processing described above.

For the sake of clarity, the description below is given by way of specific examples.

In the examples, it is assumed that prior to the file update processing, the recording medium 107 stores: the file system information 110 shown in FIG. 6; the file index lists 111 (i.e. 301 and 302) shown in FIGS. 3A and 3B, respectively; the file data lists 114 (i.e. 201 and 202) shown in FIGS. 2A and 2B, respectively; file indexes 112 (i.e. 401 and 403) shown in FIGS. 4A and 4C, respectively; and the data clusters 113. Note that of the file index lists 301 and 302, the file index list 301 bearing the larger value time stamp is the most recently updated one. Of the file data lists 201 and 202, the file data list 201 bearing the larger value time stamp is the most recently updated one. Of the data clusters 113, a group of data clusters associated with the file index 401 is referred to as a “pre-update file 1”, whereas a group of data clusters associated with the file index 403 is referred to as a “pre-update file 2”.

It is further assumed that, the recording medium 107 after the file update processing comes to store: the file index lists 111 (i.e. 301 and 303) shown in FIGS. 3A and 3C, respectively; the file data lists 114 (i.e. 201 and 203) shown in FIGS. 2A and 2C, respectively; the file indexes 112 (i.e. 401-404) shown in FIGS. 4A-4D, respectively; and data clusters 113. Note that the file index list 303 is the most recently updated version and has replaced the file index list 302. The file data list 203 is the most recently updated version and has replaced the file data list 202. The file index 402 is the most recently updated version of the file index associated with the file 1 and has replaced the file index 401, whereas the file index 404 is the most recently updated version of file index associated with the file 2 and has replaced the file index 403. Of the data clusters 113, a group of data clusters associated with the file index 402 is referred to as a “post-update file 1”, whereas a group of data clusters associated with the file index 404 is referred to as a “post-update file 2”.

Now, a description is given to the file update preparatory processing on precondition that the above file update processing is performed first on the pre-updated file 1 and then on the pre-update file 2.

(1) Abnormal Termination of File Update Processing by End of Step S503

In the case where an abnormal termination takes place during the file update processing but before the end of the step S503, no data write access has been made to the recording medium 107 in the file update processing. Thus, in the subsequent file update preparatory processing, the file update control unit 105 loads the following to the RAM: the file system information 110 shown in FIG. 6; the file index lists 111 (i.e. 301 and 302) shown in FIGS. 3A and 3B, respectively; the file data lists 114 (i.e. 201 and 202) shown in FIGS. 2A and 2B, respectively; the file indexes 112 (i.e. 401 and 403) shown in FIGS. 4A and 4C, respectively. Here, the file index list 301 is designated as a valid file index list 111, and the file data list 201 is designated as a valid file data list 114.

As a result, the file indexes 112 referenced after the startup of the data recording apparatus 100 will be the file index 401 associated with the pre-update file 1 and the file index 403 associated with the pre-update file 2. Consequently, consistency is maintained among the files that are accessible after the startup.

(2) Abnormal Termination of File Update Processing after End of Step S504 and Before End of Step S506 Each for First Iteration

Suppose that an abnormal termination of the file update processing takes place between the end of the step S504 and the end of the step S506, each step performed for the first time. In this case, by the time of the abnormal termination, the post-update file 1 has been recorded to the recording medium 107. Yet, the file index 112 (i.e. 402 shown in FIG. 4B) has not been recorded to the recording medium 107, although the file index 402 is the one associated with the post-update file 1. Thus, upon a startup of the data recording apparatus 100, the file update control unit 105 performs the same file preparatory processing as the one performed after the abnormal termination (1) described above.

As a result, the file indexes 112 referenced after the startup will be the file index 401 associated with the pre-update file 1 and the file index 403 associated with the pre-update file 2. That is to say, the post-update file 1 is not accessible. Consequently, consistency is maintained among the files that are accessible after the startup.

(3) Abnormal Termination of File Update Processing after End of Step S507 and Before End of Step S508 Each for First Iteration

Suppose that an abnormal termination of the file update processing takes place between the end of the step S507 and the end of the step S508, each step performed for the first time. In this case, by the time of the abnormal termination, the recording medium 107 comes to store the post-update file 1 and the file index 112 (i.e. 402 shown in FIG. 4B) associated with the post-update file 1. Yet, the file index list 111 (i.e. 303 shown in FIG. 3C) has not been recorded to the recording medium 107, although the file index list 303 is the one associated with the file index 402. Thus, in the file update preparatory processing after the startup, the file update control unit 105 fails to specify the address of the file index 112 (i.e. 402) from the file index list 111 loaded to the RAM. Consequently, the same file preparatory processing is performed just as the one performed after the abnormal termination (1) described above.

As a result, the file indexes 112 referenced after the startup will be the file index 401 associated with the pre-update file 1 and the file index 403 associated with the pre-update file 2. That is to say, the post-update file 1 is not accessible. Consequently, consistency is maintained among the files that are accessible after the startup.

(4) Abnormal Termination of File Update Processing after End of Step S504 and Before End of Step S506, Each for Second Iteration

Suppose that an abnormal termination of the file update processing takes place between the end of the step S504 and the end of the step S506, each step performed for the second time. In this case, by the time of the abnormal termination, the recording medium 107 comes to store the post-update file 1, the file index 112 (i.e. 402 shown in FIG. 4B) associated with the post-update file 1, and the post-update file 2. Yet, the file index list 111 (i.e. 303) that is shown in FIG. 3C and the file index 112 (i.e. 404) shown in FIG. 4D have not been recorded to the recording medium 107, although the former is the file index list associated with the file index 402 and the latter is the file index 404 associated with the post-update file 2. Thus, in the file update preparatory processing after the startup, the file update control unit 105 performs the same file preparatory processing as the one performed after the abnormal termination (1) described above.

As a result, the file indexes 112 referenced after the startup will be the file index 401 associated with the pre-update file 1 and the file index 403 associated with the pre-update file 2. Consequently, consistency is maintained among the files that are accessible after the startup.

(5) Abnormal Termination of File Update Processing after End of Step S507 and Before End of Step S508 Each for Second Iteration, or Before End of S509

Suppose that an abnormal termination of the file update processing takes place between the end of the step S507 and the end of the step S508, each step performed for the second time, or before the end of the step S509. In this case, by the time of the abnormal termination, the recording medium 107 comes to store the post-update file 1, the file index 112 (i.e. 402 shown in FIG. 4B) associated with the post-update file 1, the post-update file 2, and the file index 112 (i.e. 404 shown in FIG. 4C) associated with the post-update file 2. Yet, the file index list 111 (i.e. 303 shown in FIG. 3C) associated with the file indexes 402 and 404 has not yet recorded to the recording medium 107. Thus, in the file update preparatory processing after the startup, the file update control unit 105 fails to specify the addresses of the file indexes 112 (i.e. 402 and 404) from the file index list 111 loaded to the RAM. Consequently, the file preparatory processing is performed just as the one performed after the abnormal termination (1) described above.

As a result, the file indexes 112 referenced after the startup will be the file index 401 associated with the pre-update file 1 and the file index 403 associated with the pre-update file 2. Consequently, consistency is maintained among the files that are accessible after the startup.

(6) Abnormal Termination of File Update Processing after End of Step S510

Suppose that an abnormal termination of the file update processing takes place after the end of the step S510. In this case, by the time of the abnormal termination, the recording medium 107 comes to store the post-update file 1, the file index 112 (i.e. 402 shown in FIG. 4B) associated with the post-update file 1, the post-update file 2, the file index 112 (i.e. 404 shown in FIG. 4D) associated with the post-update file 2. In addition, the recording medium 107 by that time comes to store the file index list 111 (i.e. 303 shown in FIG. 3B) associated with the file indexes 402 and 404, in place of the file index list 111 (i.e. 302 shown in FIG. 3B). Thus, in the file update preparatory processing after the startup, the file update control unit 105 loads the following to the RAM: the file system information 110 shown in FIG. 6, the file index lists 111 (i.e. 301 and 303) shown in FIGS. 3A and 3C, respectively; the file data lists 114 (i.e. 201 and 202) shown in FIGS. 2A and 2B, respectively; and the file indexes 112 (i.e. 401 and 403) shown in FIGS. 4A and 4C, respectively.

In this case, the time stamp of the file index list 111 (i.e. 303) loaded to the RAM matches neither of the time stamps of the file data lists 114 (i.e. 201 and 202) also loaded to the RAM. Consequently, in the file preparatory processing after the startup, the file index list 111 (i.e. 303) is not designated as a valid file index list 111. Rather, the file index list 111 (i.e. 301) which is a pre-update version is designated as the valid file index list 111. As a result, the file indexes 112 referenced after the startup will be the file index 401 associated with the pre-update file 1 and the file index 403 associated with the pre-update file 2. Consequently, consistency is maintained among the files that are accessible after the startup.

(7) Abnormal Termination of File Update Processing after End of Step S511

Suppose that an abnormal termination of the file update processing takes place after the end of the step S511. In this case, by the time of the abnormal termination, the recording medium 107 comes to store the post-update file 1, the file index 112 (i.e. 402 shown in FIG. 4B) associated with the post-update file 1, the post-update file 2, and the file index 112 (i.e. 404 shown in FIG. 4D) associated with the post-update file 2. In addition, the recording medium 107 stores the file index list 111 (i.e. 303 shown in FIG. 3C) associated with the file indexes 402 and 404, in place of the file index list 111 (i.e. 302 shown in FIG. 3B). In addition, the recording medium 107 stores the file data list 114 (i.e. 203 shown in FIG. 2C), in place of the file data list 114 (i.e. 202 shown in FIG. 2B). Thus, in the file update preparatory processing after the startup, the file update control unit 105 loads the following to the RAM: the file system information 110 shown in FIG. 6; the file index lists 111 (i.e. 301 and 303) shown in FIGS. 3A and 3C, respectively; the file data lists 114 (i.e. 201 and 203) shown in FIGS. 2A and 2C, respectively; and the file indexes 112 (i.e. 401 and 403) shown in FIGS. 4A and 4C, respectively. Here, the file index list 111 (i.e. 303) is designated as a valid file index file 111, and the file data list 114 (i.e. 203) is designated as a valid file data list 114.

As a result, the file indexes 112 referenced after the startup will be the file index 402 associated with the post-update file 1 and the file index 404 associated with the post-update file 2. Consequently, consistency is maintained among the files that are accessible after the startup.

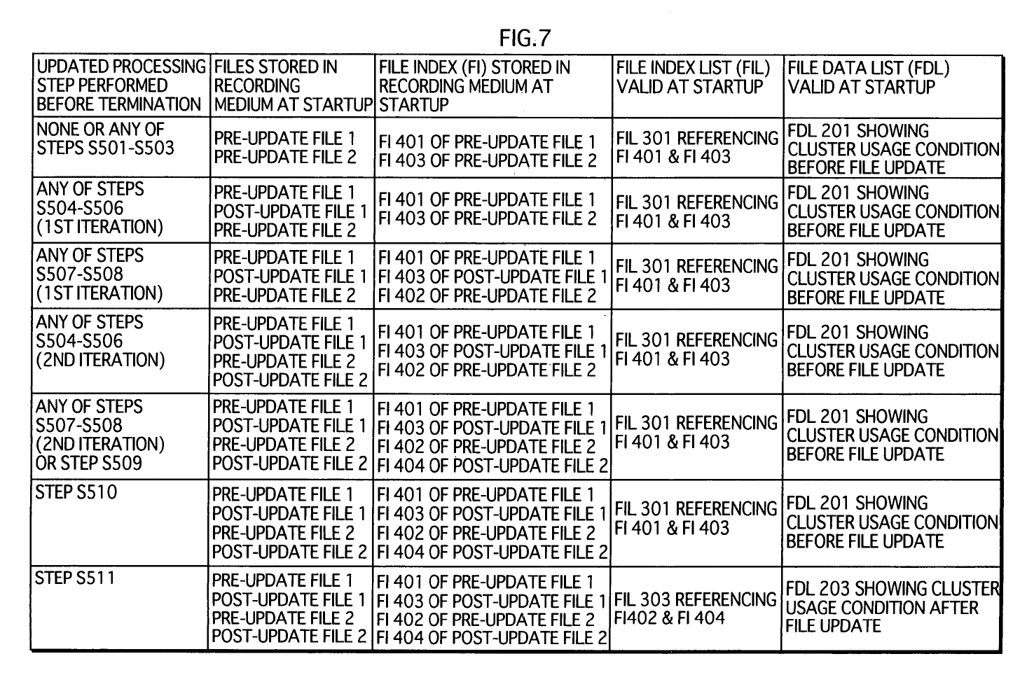

FIG. 7 is a table showing the files and file indexes 112 that are stored in the recording medium 107 as well as the file index list 111 and the file data list that are valid at the time of startup after an abnormal termination of the file update processing occurred in a respective step shown in FIG. 5.

As described above, according to the file update processing of the embodiment, consistency among the accessible files is maintained even if the file update processing is abnormally terminated at any stage. In addition, the consistency is maintained without requiring no recovery processing to be performed after the startup.

Supplemental Notes

Up to this point, the data recording apparatus 100 according to the present invention has been described by way of the above preferred embodiment. However, it is naturally appreciated that the present invention is in no way limited to the specific embodiment described above.

(1) For example, the file update processing according to the above embodiment may be applied not only for updating files, but also for generating multiple files that are mutually related.

By applying the file update processing, when the file generation processing is abnormally terminated before recording the data of all the files generated, consistency among the files at the time of startup is ensured.

(2) According to the above embodiment, the file data list management unit 101 keeps track of the storage locations of the file data in the unit of clusters. Yet, the storage locations may be managed in the unit of cluster groups each composed of multiple clusters of the consecutive addressees.

This arrangement serves to reduce the storage capacity necessary for storing the file data lists 114.

(3) The file update processing according to the present embodiment may be applied to the update processing of such multiple files that causes a problem if only some of the files are updated. On example is a pair of files, one storing video stream data and the other storing management information of the video stream. Another example is a pair of files, one storing a message body of e-mail and the other storing index information of the e-mail. Yet another example is multiple files together constituting a web site.

(4) Each file index 112 of the above embodiment may additionally contain attribute information of the file, such as the data size and the recording date/time. Furthermore, each file index 112 may additionally contain information about the file index itself, such as the data size.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A data recording apparatus having a recording medium, for accessing files on the recording medium with reference to specification information used for specifying storage locations of the files, comprising:
a data receiving unit operable to receive file data constituting a plurality of files, on a file-by-file basis;
a data recording unit operable to record the received file data onto the recording medium; and
a specification information recording unit operable to, on completion of the recording of the received file data, generate and record to the recording medium specification information for the files constituted of the received file data.

2. The data recording apparatus according to claim 1, wherein
the recording medium stores (i) file data constituting files being a pre-update version of the files constituted of the received file data, and (ii) specification information for the pre-update version of files, and
the specification information recording unit invalidates the previously stored specification information, and validates the specification information generated on completion of the recording of the received file data.

3. The data recording apparatus according to claim 2, further comprising:
a storage location recording unit operable to, each time the recording of the received file data is completed for one file, generate and record to the recording medium a piece of storage location information showing a storage location of the file, an access to the file being made with reference to the storage location information, wherein
the specification information specifies a storage location of each piece of storage location information, and
the specification information recording unit generates the specification information, on completion of the recording of the storage location information for the files constituted of the received file data.

4. The data recording apparatus according to claim 3, wherein
the recording medium includes:
a file data recording area composed of a plurality of clusters; and
a table recording area storing a cluster usage table showing a usage condition of the clusters, and
the data recording unit includes:
a cluster specifying subunit operable to specify, with reference to the cluster usage table, unused clusters available for storing the received file data;
a cluster recording subunit operable to record the received file data to the specified clusters;
an updated table generating subunit operable to generate a cluster usage table in which a usage condition of the specified clusters is updated; and
a table update subunit operable to record the generated cluster usage table to the recording medium, on completion of the recording of the storage location information for the files.

5. The data recording apparatus according to claim 4, further comprising:
a group file specifying unit operable to specify a plurality of files to be updated as a group, wherein
the data receiving unit receives the file data for the specified group of files.

6. A data recording method for use by a data recording apparatus having a recording medium and accessing files on the recording medium with reference to specification information used for specifying storage locations of the files, the data recording method comprising the steps of:
receiving file data constituting a plurality of files, on a file-by-file basis;
recording the received file data onto the recording medium; and
generating and recording to the recording medium, on completion of the recording of the received file data, specification information for the files constituted of the received file data.

7. A program for use by a data recording apparatus having a recording medium and accessing files on the recording medium with reference to specification information used for specifying storage locations of the files file, the program comprising:
code operable to cause the apparatus to receive file data constituting a plurality of files, on a file-by-file basis;
code operable to cause the apparatus to record the received file data onto the recording medium; and
code operable to cause, on completion of the recording of the received file data, the apparatus to generate and record to the recording medium specification information for the files constituted of the received file data.

8. A computer-readable recording medium storing a program for used by a data recording apparatus having another recording medium and accessing files on said another recording medium with reference to specification information used for specifying storage locations of the files, the program comprising:
code operable to cause the apparatus to receive file data constituting a plurality of files, on a file-by-file basis;
code operable to cause the apparatus to record the received file data onto the recording medium; and
code operable to cause, on completion of the recording of the received file data, the apparatus to generate and record to the recording medium specification information for the files constituted of the received file data.
